(19) United States
(12) Patent Application Publication
(10) Pub. No.: US 2024/0100657 A1
(43) Pub. Date: Mar. 28, 2024

(54) FASTENING WORK MANAGEMENT SYSTEM AND FASTENING WORK CONTROL METHOD

(71) Applicant: TOYOTA JIDOSHA KABUSHIKI KAISHA, Toyota-shi (JP)

(72) Inventor: Keisuke MIURA, Toyota-shi (JP)

(73) Assignee: TOYOTA JIDOSHA KABUSHIKI KAISHA, Toyota-shi (JP)

(21) Appl. No.: 18/452,255

(22) Filed: Aug. 18, 2023

(30) Foreign Application Priority Data
Sep. 27, 2022 (JP) 2022-153415

(51) Int. Cl. B25B 21/00; B25B 23/147; G06T 7/00; G06T 7/70

(52) U.S. Cl. CPC B25B 21/002; B25B 23/147; G06T 7/001; G06T 7/70; G06T 2207/30164

(57) ABSTRACT

A fastening work management system according to the present disclosure manages a fastening work of fastening a fastened member in a predefined fastening order to a plurality of fastening positions of a target member by using a fastening tool that is grasped and operated by an operator. The fastening work management system includes an image acquisition unit configured to acquire an inspection image including a position defined as a current fastening position in the fastening order included in the fastening work management information when the fastening work of a predetermined fastened member is completed and a detection unit configured to detect whether or not the fastened member, which has been fastened, is present at the current fastening position included in the inspection image.

### CROSS REFERENCE TO RELATED APPLICATIONS

This application is based upon and claims the benefit of priority from Japanese patent application No. 2022-153415, filed on Sep. 27, 2022, the disclosure of which is incorporated herein in its entirety by reference.

### BACKGROUND

The present disclosure relates to a fastening work management system and a fastening work control method for managing a fastening work of fastening a fastened member in a predefined fastening order to a plurality of fastening positions of a target member by using a fastening tool that is grasped and operated by an operator in a product line of a factory or the like.

Fastening of a fastened member is an example of a method of coupling and fixing parts. Examples of the fastened member include screws such as bolts and nuts. Traditionally, a system for appropriate fastening has been suggested in a fastening work of a fastened member. For example, in the system described in Japanese Unexamined Patent Application Publication No. 2017-140681, an image of a predetermined area including a feature part provided on a part is captured, and a position of a fastening work is specified based on a position of the feature part in the captured image. In this system, it is determined to be normal when the fastening work is being performed at the fastening position. In this way, the system manages whether a fastening work is being performed in a predefined fastening order.

The system described in Japanese Unexamined Patent Application Publication No. 2002-346857 includes position coordinate detection means for detecting position coordinates of a fastening tool. In this system, the position coordinate of the fastening tool is compared with a fastening position of a part to determine whether they match. In the system, a fastening order and a target fastening torque are set for a plurality of fastening positions to reduce work mistakes.

### SUMMARY

However, in the technique described in Japanese Unexamined Patent Application Publication No. 2017-140681, a part must be provided with a feature part to determine whether a fastening work is performed at a correct position. Further, in the technique described in Japanese Unexamined Patent Application Publication No. 2002-346857, the fastening tool must be provided with a rotation angle detector.

The present disclosure has been made to solve such a problem and an object thereof is to provide a fastening work management system and a fastening work management method that can appropriately manage a fastening order of a fastening work that fastens a fastened member in a predefined fastening order at a plurality of fastening positions of a target member.

A fastening work management system according to the present disclosure is for managing a fastening work of fastening a fastened member in a predefined fastening order to a plurality of fastening positions of a target member by using a fastening tool that is grasped and operated by an operator, the fastening work management system including:
a storage unit configured to store fastening work management information including the fastening order of the fastened members for each of the plurality of fastening positions;
an image acquisition unit configured to acquire an inspection image including a position defined as a current fastening position in the fastening order included in the fastening work management information when the fastening work of a predetermined fastened member is completed;
a detection unit configured to detect whether or not the fastened member, which has been fastened, is present at the current fastening position included in the inspection image; and
a determination unit configured to determine that the fastening work at the current fastening position is normal when the fastened member is detected. With such a configuration, it is possible to determine whether the fastened member is fastened to the current fastening position in a predefined fastening order.

Here, the image acquisition unit acquires the inspection image by trimming a partial image including the current fastening position from a whole image including all of the fastening positions defined as positions of the target member where the fastened members are to be fastened. With such a configuration, since it is not necessary to move a camera when acquiring the inspection image, the inspection image can be acquired efficiently and accurately.

Further, when the determination unit determines that the detection of the fastened member is indeterminable, the image acquisition unit re-acquires the inspection image after a predetermined period of time, and

the detection unit re-executes detection processing based on the re-acquired inspection image. With such a configuration, it is possible to prevent erroneous determination due to poor capturing of the inspection image.

In response to receiving, from the fastening tool, a completion signal transmitted when the fastening with a predetermined torque is completed, the image acquisition unit starts executing processing for acquiring the inspection image. With such a configuration, when the fastening work of the operator is completed, the inspection image can be automatically acquired.

In the fastening work management information, identification information about the target member is associated with the fastening order of the fastened member. With such a configuration, the same production line can be used for inspection based on the identification information about the target member, even if the fastening order of the fastened member is different depending on the target member.

The target member is a cover member attached to a battery. Since the battery performance is greatly affected by whether the cover is fastened and fixed to the battery by a uniform load, degradation of the battery performance can be prevented by applying fastening work management system according to the present disclosure.

A fastening work management method according to the present disclosure is for managing a fastening work of fastening a fastened member in a predefined fastening order to a plurality of fastening positions of a target member by using a fastening tool that is grasped and operated by an operator, the fastening work management method including:
acquiring an inspection image including a position specified as a current fastening position in the defined fastening order when the fastening work of a predetermined fastened member is completed; and
detecting whether or not the fastened member, which has been fastened, is present at the current fastening position included in the inspection image. With such a configuration, it is possible to determine whether the fastened member is fastened to the current fastening position in a predefined fastening order.

In the acquiring of the inspection image, the inspection image is acquired by trimming a partial image including the current fastening position from a whole image including all of the fastening positions defined as the positions of the target member where the fastened members are to be fastened. With such a configuration, since it is not necessary to move a camera when acquiring the inspection image, the inspection image can be acquired efficiently and accurately.

A fastening work management method according to the present disclosure is for managing a fastening work of fastening a fastened member in a predefined fastening order to a plurality of fastening positions of a cover member to be attached to a battery by using a fastening tool that is grasped and operated by an operator, the fastening work management method including:
acquiring an inspection image including a position specified as a current fastening position in the defined fastening order when the fastening work of a predetermined fastened member is completed; and
detecting whether or not the fastened member, which has been fastened, is present at the current fastening position included in the inspection image.

According to the present disclosure, it is possible to provide a fastening work management system and a fastening work management method that can appropriately manage a fastening order of a fastening work that fastens a fastened member in a predetermined fastening order at a plurality of fastening positions of a target member.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a schematic diagram of a fastening work management system according to a first embodiment;

FIG. 2 shows a target member to which a fastened member is to be fastened according to the first embodiment;

FIG. 3 is a side view of a nut runner according to the first embodiment;

FIG. 4 is an example of fastening work management information according to the first embodiment;

FIG. 5A is an example of a whole image according to the first embodiment;

FIG. 5B shows an inspection image which is a partial image according to the first embodiment; and

FIG. 6 is a flowchart showing a fastening work management method according to the first embodiment.

### DESCRIPTION OF EMBODIMENTS

### First Embodiment

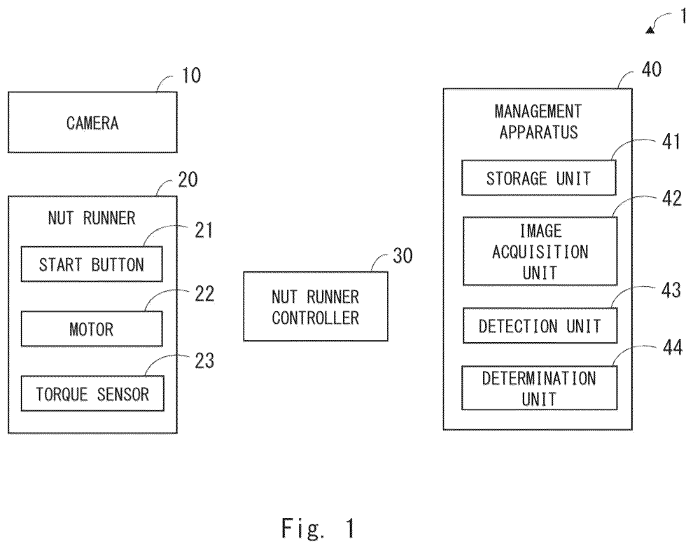

FIG. 1 is a schematic diagram of a fastening work management system according to a first embodiment. A fastening work management system 1 includes a camera 10, a nut runner 20, a nut runner controller 30, and a management apparatus 40.

The camera 10 is capturing means that captures an image of a target member, generates a still image, and then outputs the generated still image. The camera 10 is provided to capture the whole target member including all fastening positions defined as the positions of the target member where fastened members are to be fastened from right above the target member. The camera 10 is installed, for example, above the position of an operator's head. Note that the position of the camera 10 may not be such that the target member is captured from right above the target member, but it may be such that the target member is captured from an oblique direction. Moreover, although only one camera 10 is provided in this embodiment, a plurality of cameras may be provided.

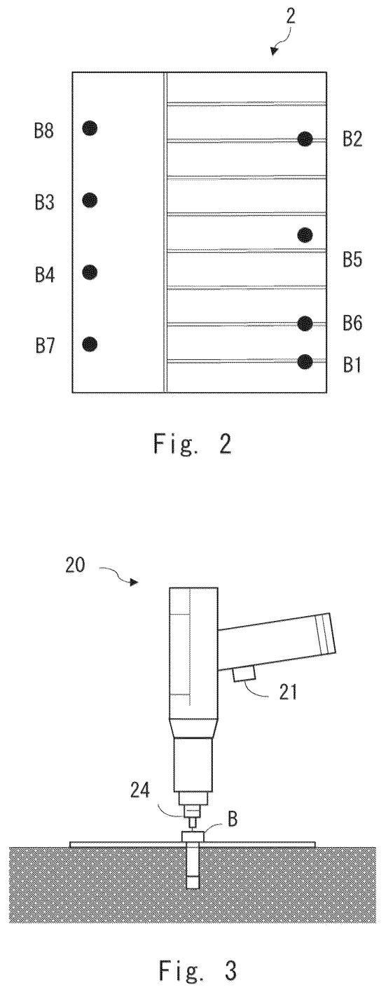

FIG. 2 shows a target member for coupling fastened members. In this embodiment, the target member is a cover member 2 attached to a battery pack included in a vehicle. In the cover member 2, all eight fastening positions (B1-B8) are defined as the positions where bolts that are fastened members should be fastened, and through holes are provided at these positions. In this example, the fastening positions are set dispersed in a peripheral area in front view of the cover member 2. When each bolt is fastened, the bolt shall be fastened in a predefined fastening order with a fastening tool grasped by the operator. There is no limit in the number of fastening positions of the bolts, but in a suitable example, there may be four or more fastening positions.

The nut runner 20 is a fastening tool that fastens the cover member 2 to the battery pack by fastening the bolts through the holes. In this embodiment, the nut runner 20 is controlled by the nut runner controller 30. Thus, in a broad sense, it can also interpreted that the nut runner 20 and the nut runner controller constitute the fastening tool.

The nut runner 20 includes a motor 22, a start button 21 for starting the motor 22, and a torque sensor 23. FIG. 3 is a side view of the nut runner 20. In this embodiment, the nut runner 20 is a so-called hand nut runner, and the operator usually grasps the nut runner 20 with one hand, moves it to the fastening position, and then fastens bolts B. The nut runner 20 includes a socket part 24 at a leading end. The socket part 24 has a button system and is rotated when the start button 21 is pressed. By placing the socket part 24 on the head of the bolt B and pressing the start button 21 while holding the head of the bolt B, the motor 22 is driven to fasten the bolt B to the through hole of the cover member 2.

FIG. 3 shows the nut runner 20 for fastening the bolts B. The nut runner can be applied to any fastening tool that can fasten fastened members such as screws, not limited to the bolt B or nuts. Depending on the fastened member, the rotating leading end may be a socket or a rivet. In addition, instead of a button system, a push-start system can be used in which the rotation of the nut runner 20 starts automatically by pressing the leading end thereof against the fastened member.

A torque at the time of fastening a bolt can be set in the nut runner 20. The fastening torque of the nut runner 20 is set from the management apparatus according to a production instruction. Alternatively, the fastening torque of the nut runner 20 can be set by the nut runner controller 30 connected to the nut runner 20.

The torque sensor 23 measures the actual torque at the time of fastening a bolt. The torque sensor 23 transmits a completion signal to the nut runner controller 30 when fastening of the bolt B is completed within a preset torque range. In response to receiving the completion signal, the nut runner controller transmits the completion signal to the management apparatus 40. In this embodiment, the nut runner 20 and the nut runner controller 30 are communicatively connected in a wireless manner, and instead the nut runner 20 and the nut runner controller 30 may be communicatively connected in a wired manner. Furthermore, in this embodiment, the nut runner controller 30 and the management apparatus 40 are communicatively connected in a wired manner, and instead the nut runner controller 30 and the management apparatus 40 may be communicatively connected in a wireless manner.

The nut runner controller 30 drives the motor 22 of the nut runner 20 when the start button 21 is pressed. When the fastening torque received from the torque sensor 23 reaches within the set fastening torque range, nut runner controller 30 stops driving the motor 22.

In this embodiment, the nut runner 20 and the nut runner controller 30 are composed of different devices, and instead the nut runner 20 may include the nut runner controller 30 and be composed of one device.

The management apparatus 40 constitutes a fastening work management system in a narrow sense. The management apparatus 40 includes a storage unit 41, an image acquisition unit 42, a detection unit 43, and a determination unit 44. The management apparatus 40 is composed of a computer including a Central Processing Unit (CPU), RAM, and ROM, and achieves the functions of the storage unit 41, the image acquisition unit 42, the detection unit 43, and the determination unit 44 by executing pre-installed programs. The processing of the management apparatus 40 may be distributed among a plurality of computers such as a facility PLC (Programmable Logic Controller), an inference edge computer, and a data storage computer.

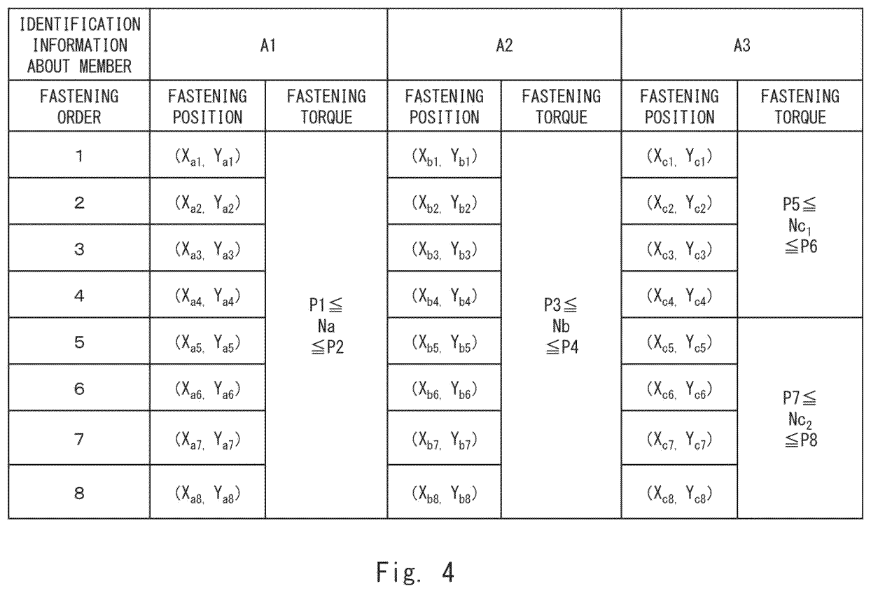

The storage unit 41 stores the fastening work management information including the fastening order of the bolt for each of the plurality of fastening positions of the cover member 2. In addition, the storage unit 41 stores identification information about the cover member 2 in association with the fastening order of the bolts. FIG. 4 is an example of the fastening work management information. In the example in which the identification information is A1, there are eight fastening positions of the bolts B, and as the position information, it is defined that the bolts should be fastened with a torque within a preset torque range (P1≤N≤P2) in the order of coordinates (Xa1, Yb1), (Xa2, Yb2), (Xa3, Yb3), and . . . (Xa8, Yb8). That is, in this embodiment, the cover member 2, which is the target member, has a different fastening position, a different fastening order, and a different fastening torque for different types of the cover member 2, and it is possible to perform a fastening work according to each type of the cover member 2. In this example, the identification information about the cover member 2, which is the target member, is included in the fastening work management information. Alternatively or additionally, the fastening work management information may include vehicle type information that identifies a vehicle in which the battery to which the cover member 2 is attached.

When the fastening work of the predetermined bolt B is completed, the image acquisition unit 42 acquires an inspection image including the position defined as a current fastening position in the fastening order included in the fastening work management information. Specifically, the image acquisition unit 42 recognizes the completion of the fastening work of the predetermined bolt by receiving the completion signal from the nut runner controller 30, and starts executing processing for acquiring the inspection image. In the processing for acquiring the inspection image, the image acquisition unit 42 outputs a signal requesting the camera 10 to execute processing for capturing an image of the cover member 2.

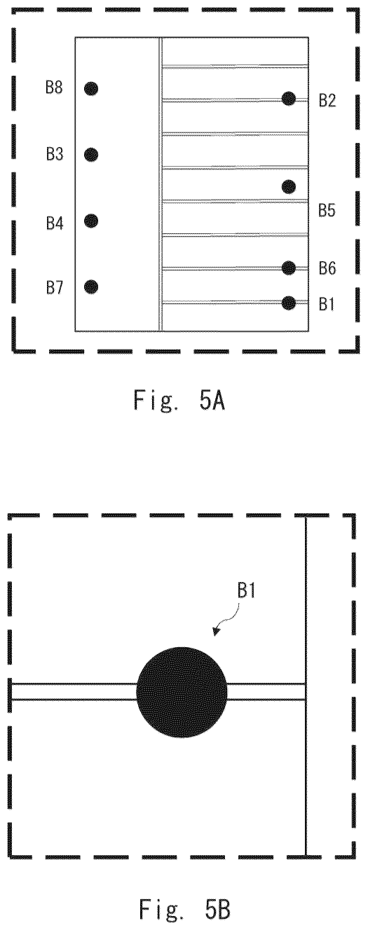

FIG. 5A shows an example of the whole image and FIG. 5B shows the inspection image which is a partial image. In this embodiment, in particular, the image acquisition unit 42 acquires the inspection image from the whole image of the cover member 2 by trimming the partial image including the current fastening position of the bolt B. In this embodiment, after the whole image is captured by the camera 10, the inspection image, which is a partial image, is acquired from the whole image by trimming the inspection image, therefore, no mechanical mechanism is required to move a capturing range of the camera 10 so that only the current fastening position can be captured. Thus, according to this embodiment, an inspection image which includes a current fastening position can be acquired with high accuracy without preparing a complicated mechanism.

The detection unit 43 detects whether or not the fastened bolt B is present in the current fastening position included in the inspection image. The detection unit 43 is composed of an inference edge computer with an image recognition function by machine learning using AI. This detection processing may use, for example, an object detection method (R-CNN). Moreover, the detection unit 43 detects whether or not a bolt is present by using a learned model for bolt detection that has learned an image in which the bolt B is present at the fastening position and an image in which the bolt B is not present at the fastening position. The detection unit 43 outputs, for example, the probability that the bolt B is present at the fastening position and the probability that the bolt B is not present at the fastening position as detection results.

When the bolt B is detected, the determination unit 44 determines that the fastening work at the current fastening position is normal. When the bolt B is not detected, the determination unit 44 determines that the fastening work at the current fastening position is abnormal and executes an abnormal procedure. When the determination unit 44 determines that the detection of a bolt by the detection unit 43 is indeterminable, the image acquisition unit 42 re-acquires the inspection image after a predetermined period of time, and the detection unit 43 re-executes the inspection processing.

When the detection of a bolt is indeterminable, the probability that the bolt B is present at the fastening position is less than a predetermined reference value, and the probability that the bolt B is not present at the fastening position is also less than the predetermined reference value. In other words, when the detection of a bolt is indeterminable, it is impossible to determine whether or not the bolt B is present at the fastening position. For example, when a part of the operator or the nut runner 20 appears in the inspection image obtained by capturing the fastening position and fastening position is shielded. Thus, when the detection of a bolt is indeterminable due to an appearance of the operator or the like, if the inspection processing is re-executed after a predetermined period of time, the processing for detecting a bolt can be executed efficiently and accurately, because it is highly possible that such appearance may have been resolved.

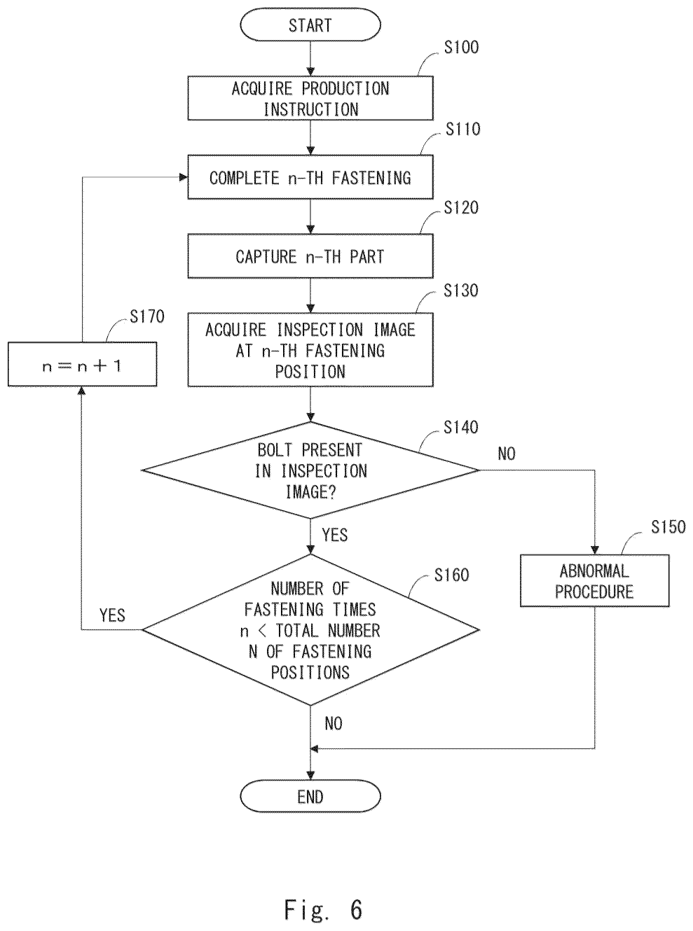

FIG. 6 is a flowchart showing a fastening work management method. The fastening work management method is a method of managing the fastening order of the bolt B by using the acquired inspection image. This method is done repeatedly while the production line is in operation where the operator manually operates the nut runner 20 to fasten the bolt B to the cover member 2.

In Step S100, the management apparatus 40 acquires a production instruction including the identification information about the cover member 2. Next, based on the identification information about the cover member 2, the fastening order, the fastening position, and the fastening torque of the bolt B are acquired from the fastening work management information stored in the storage unit 41. The management apparatus 40 sets the fastening torque of the nut runner 20 by transmitting the acquired fastening torque to the nut runner controller 30.

In Step S110, the nut runner controller 30 stops driving the motor 22 when the fastening torque received from the torque sensor 23 reaches within the set fastening torque range. The nut runner controller 30 then sends a completion signal to the management apparatus 40.

In Step S120, in response to receiving the completion signal, the management apparatus 40 captures the whole cover member 2 by using the camera 10. Here, the image is preferably captured 1 to 5 seconds after receiving the completion signal, not right after receiving it. In a more preferable example, the image is captured 1 to 2 seconds after receiving the completion signal. If an image is captured right after the completion signal is received, there is a high possibility that the nut runner 20 or the operator will appear at the current fastening position and that the bolt B that is fastened this time may not appear in the image.

In Step S130, the image acquisition unit 42 acquires a whole image including the whole cover member 2 captured by the camera 10. Next, based on the fastening order and the fastening position of the bolt B, the image acquisition unit 42 acquires, from the whole image, the position information specified as the current fastening position in the defined fastening order. The inspection image is acquired by trimming the partial image including the specified fastening position from the acquired position information.

In Step S140, the detection unit 43 detects whether or not the fastened bolt B is present in the acquired inspection image. When the bolt B is detected, the determination unit 44 determines that the fastening work at the current fastening position is normal. When the bolt B is not detected, the determination unit 44 determines that the fastening work at the current fastening position is abnormal. When it is determined that the fastening work is abnormal in Step S140, the processing proceeds to Step S150, while when it is determined that the fastening work is normal, the processing proceeds to Step S160.

In Step S150, the abnormal procedure is performed. The abnormal procedure includes, for example, notifying the operator or stopping the driving of the motor 22. By performing the abnormal procedure, it is possible to immediately recognize that the fastening work is abnormal and stop the work. This prevents the work from proceeding with a wrong fastening order of the bolt B.

In Step S160, it is determined whether the number n of times the bolts B are fastened is equal to a total number N of fastening positions. The total number N of fastening positions is a sum of the number of all fastening positions included in the cover member 2 as the positions where the bolts B should be fastened. In this embodiment, the number of the fastening positions of the bolts B is 8, so N=8. When the number n of times the bolts B are fastened has reached the total number N of fastening positions, it is determined that the fastening work is completed normally and the processing is ended. When the number n of times the bolts B are fastened has not reached the total number N of fastening positions, the processing proceeds to Step S170.

In Step S170, the number n of times the bolts are fastened is updated to n+1. Then, the processing returns to Step S110.

In this embodiment, as shown in FIG. 2, the cover member 2 includes all eight fastening positions for the bolts B (B1 to B8). In other words, the total number of fastening positions of the bolts B is eight (N=8). First, after fastening the first B1 of the fastening position of the bolt B, a first inspection to determine whether or not a first (n=1) fastening work is normal is carried out. Similarly, after fastening the second B2 of fastening position of the bolt B, an inspection on a second (n=2) fastening work is carried out, and after fastening the third B3 of the bolt B, an inspection on a third (n=3) fastening work is carried out. After fastening the eighth B8 of the fastening position of the bolt B, which is the last one of fastening position of the bolt B, an inspection on a eighth (n=8) fastening work is carried out. When it is determined that the eighth (n=8) fastening work is normal, since the number (n=8) of times the bolts B are fastened has reached the total number of fastening positions (N=8), the processing is ended.

In the fastening work management method shown in FIG. 6, the number of inspections is defined as the number of fastening times, which is the number of fastening works carried out, but the number of inspections may be less than the number of fastening times. When the fastening order is managed, the number of inspections may be one less than the number of fastenings times. Also, if the initial fastening order becomes particularly important, only the initial fastening positions may be inspected.

According to the fastening management system and the fastening management method of the first embodiment, the current fastening position of the bolt B is specified from the inspection image of the cover member 2 acquired based on the fastening work management information. The fastening order can be appropriately managed by detecting the bolt B every time the fastening of the bolt B is completed at each fastening position.

According to the fastening management system and the fastening management method of this first embodiment, the fastening order of all the bolts B of the cover member 2 can be appropriately managed. In the cover member 2 to be attached to the battery, if the bolt B is not fastened in the appropriate order, the cover member 2 floats and quality requirements such as airtightness and waterproofness cannot be satisfied. Therefore, by fastening the bolt B in the appropriate order, the stress caused by the fastening is prevented from concentrating on some of the fastening positions and becoming uneven, thereby preventing degradation of the battery performance. Furthermore, by managing the fastening torque of the nut runner 20 together with the fastening order of the bolt B, it is possible to achieve attachment of a high-quality battery cover.

### Other Embodiment

It should be noted that the present disclosure is not limited to the above embodiment and can be modified as appropriate without departing from the scope. For example, in the above example, the camera 10 and the management apparatus are separately provided, but the present disclosure is not limited to this, and the camera 10 and camera management apparatus 40 may be integrated.

Also, in the above example, a configuration in which the inspection image is acquired every time the fastening of the bolt B is completed at one place is explained. Alternatively, the inspection image may be acquired every time the fastening of the bolts B is completed at two places. For example, when it is necessary to fasten bolts diagonally, the number of times the inspection image is acquired can be reduced by inspecting the two fastening positions together. In addition, the fastening order may be managed only for a predetermined fastening position among the plurality of fastening positions.

Also, in a typical embodiment, the inspection image is acquired by trimming the whole image, but the present disclosure is not limited to this. Alternatively, each of the plurality of inspection images including each fastening position may be acquired by changing the capturing range of the camera 10. In this case, a well-known mechanism for moving the capturing range of the camera may be applied. Furthermore, a plurality of cameras 10 that can capture a plurality of the inspection images, respectively, may be installed. In this case, no mechanism for moving the cameras 10 is required, and no trimming is required. At this time, the number of the cameras 10 provided may not be as many as the number of fastening positions, and instead an area where the whole image can be captured may be divided into areas including a plurality of fastening positions, and the camera 10 may be provided for each divided area. In this case, the image captured by each camera 10 will include the plurality of fastening positions, but by performing trimming, the inspection image including only the current fastening position can be generated.

It should be noted that the target member in the above example is not limited to the cover member 2 which is attached to the battery. However, the present disclosure is not limited to this, and the target member can be applied to members which parts need to be fastened in a predefined fastening order, such as the attachment of a differential gear or the attachment of a housing of a transmission.

The above-described program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A fastening work management system for managing a fastening work of fastening a fastened member in a predefined fastening order to a plurality of fastening positions of a target member by using a fastening tool that is grasped and operated by an operator, the fastening work management system comprising:
a storage unit configured to store fastening work management information including the fastening order of the fastened members for each of the plurality of fastening positions;
an image acquisition unit configured to acquire an inspection image including a position defined as a current fastening position in the fastening order included in the fastening work management information when the fastening work of a predetermined fastened member is completed;
a detection unit configured to detect whether or not the fastened member, which has been fastened, is present at the current fastening position included in the inspection image; and
a determination unit configured to determine that the fastening work at the current fastening position is normal when the fastened member is detected.

2. The fastening work management system according to claim 1, wherein the image acquisition unit acquires the inspection image by trimming a partial image including the current fastening position from a whole image including all of the fastening positions defined as positions of the target member where the fastened members are to be fastened.

3. The fastening work management system according to claim 1, wherein
when the determination unit determines that the detection of the fastened member is indeterminable, the image acquisition unit re-acquires the inspection image after a predetermined period of time, and
the detection unit re-executes detection processing based on the re-acquired inspection image.

4. The fastening work management system according to claim 1, wherein
in response to receiving, from the fastening tool, a completion signal transmitted when the fastening with a predetermined torque is completed, the image acquisition unit starts executing processing for acquiring the inspection image.

5. The fastening work management system according to claim 1, wherein
in the fastening work management information, identification information about the target member is associated with the fastening order of the fastened member.

6. The fastening work management system according to claim 1, wherein
the target member is a cover member attached to a battery.

7. A fastening work management method for managing a fastening work of fastening a fastened member in a predefined fastening order to a plurality of fastening positions of a target member by using a fastening tool that is grasped and operated by an operator, the fastening work management method comprising:
acquiring an inspection image including a position specified as a current fastening position in the defined fastening order when the fastening work of a predetermined fastened member is completed; and
detecting whether or not the fastened member, which has been fastened, is present at the current fastening position included in the inspection image.

8. The fastening work management method according to claim 7, wherein in the acquiring of the inspection image, the inspection image is acquired by trimming a partial image including the current fastening position from a whole image including all of the fastening positions defined as the positions of the target member where the fastened members are to be fastened.

9. A fastening work management method for managing a fastening work of fastening a fastened member in a predefined fastening order to a plurality of fastening positions of a cover member to be attached to a battery by using a fastening tool that is grasped and operated by an operator, the fastening work management method comprising:
acquiring an inspection image including a position specified as a current fastening position in the defined fastening order when the fastening work of a predetermined fastened member is completed; and
detecting whether or not the fastened member, which has been fastened, is present at the current fastening position included in the inspection image.
